(19) United States
(12) Patent Application Publication
(10) Pub. No.: US 2025/0067983 A1
(43) Pub. Date: Feb. 27, 2025

(54) VIRTUAL IMAGE DISPLAY DEVICE AND OPTICAL UNIT

(71) Applicant: SEIKO EPSON CORPORATION, Tokyo (JP)

(72) Inventor: Mitsutaka Ide, Shiojiri-shi (JP)

(73) Assignee: SEIKO EPSON CORPORATION, Tokyo (JP)

(21) Appl. No.: 18/812,594

(22) Filed: Aug. 22, 2024

(30) Foreign Application Priority Data
Aug. 23, 2023 (JP) 2023-135307

(51) Int. Cl. G02B 27/01

(52) U.S. Cl. CPC G02B 27/0172; G02B 2027/0178

(57) ABSTRACT

A virtual image display device includes a first display panel that emits first image light, a second display panel that emits second image light having a wavelength region different from the wavelength region of the first image light, a third display panel that emits third image light having a wavelength region different from the wavelength regions of the first and second image lights, and a cross dichroic prism that includes a first light incident surface for the first image light, a second light incident surface for the second image light, and a third light incident surface for the third image light and that synthesizes the first to third image lights. The virtual image display device further includes a projection optical system that includes an optical path bending prism, and a light-guiding optical system that that guides the image light emitted from the projection optical system to a pupil position.

The present application is based on, and claims priority from JP Application Serial Number 2023-135307, filed Aug. 23, 2023, the disclosure of which is hereby incorporated by reference herein in its entirety.

### BACKGROUND

### 1. Technical Field

The present disclosure relates to a virtual image display device and an optical unit that enable observation of a virtual image.

### 2. Related Art

As a display device that enables observation of a virtual image, a display device is known in which display light beams emitted from three display panels are synthesized by a synthesizing optical system including two dichroic mirrors intersecting with each other, and the synthesized light beam is incident on one end of a plate-shaped light-guiding unit and emitted from the other end of the light-guiding unit (JP-A-2018-205451).

In the display device disclosed in JP-A-2018-205451, since a prism-shaped synthesizing optical system is used, the size of the optical system up to the light-guiding unit is likely to be increased, and the size of the light-guiding unit is also increased. This results in an increase in weight, restrictions on design, and the like, which are undesirable for a user. In particular, when the light-guiding unit is of a diffraction type, it is not easy to dispose the synthesizing optical system so as not to be perpendicular to a light-guiding plate constituting the light-guiding unit but to be inclined to the outer side or the ear side. Thus, restrictions become larger in terms of the arrangement and the size of the light-guiding plate.

### SUMMARY

A virtual image display device according to an aspect of the present disclosure includes a first display panel configured to emit first image light, a second display panel configured to emit second image light having a wavelength region different from a wavelength region of the first image light, a third display panel configured to emit third image light having a wavelength region different from the wavelength regions of the first image light and the second image light, a cross dichroic prism including a first light incident surface on which the first image light is incident, a second light incident surface on which the second image light is incident, and a third light incident surface on which the third image light is incident, and configured to synthesize the first image light, the second image light, and the third image light and emit synthesized image light from a light emission surface, a projection optical system including an optical path bending prism having a first transmission surface on which the image light from the cross dichroic prism is incident, a first reflection surface and a second reflection surface that reflect the image light transmitted through the first transmission surface, and a second transmission surface that emits the image light reflected by the second reflection surface, and a light-guiding member configured to guide the image light emitted from the projection optical system to a pupil position at which an eye is located.

### BRIEF DESCRIPTION OF THE DRAWINGS

FIG. 1 is a plan view for describing a mounted state of an HMD according to a first embodiment.

FIG. 2 is a side view for describing an arrangement of an optical system included in a virtual image display device, and the like.

FIG. 3 is a plan view for describing the arrangement of the optical system included in the virtual image display device, and the like.

FIG. 4 is a rear view for describing a light-guiding optical system or a light-guiding member.

FIG. 5 illustrates a side view and a rear view for describing an optical system of a first display driving unit.

FIG. 6 is a perspective view illustrating an external appearance of an optical path bending prism.

FIG. 7 is a plan view for describing a virtual image display device according to a modified example.

FIG. 8 illustrates a side view and a rear view for describing an optical system according to a second embodiment.

FIG. 9 illustrates a side view and a rear view for describing an optical system according to a third embodiment.

FIG. 10 is a perspective view for describing an optical block illustrated in FIG. 9.

FIG. 11 is a plan view for describing an optical system according to a modified example.

### DESCRIPTION OF EMBODIMENTS

### First Embodiment

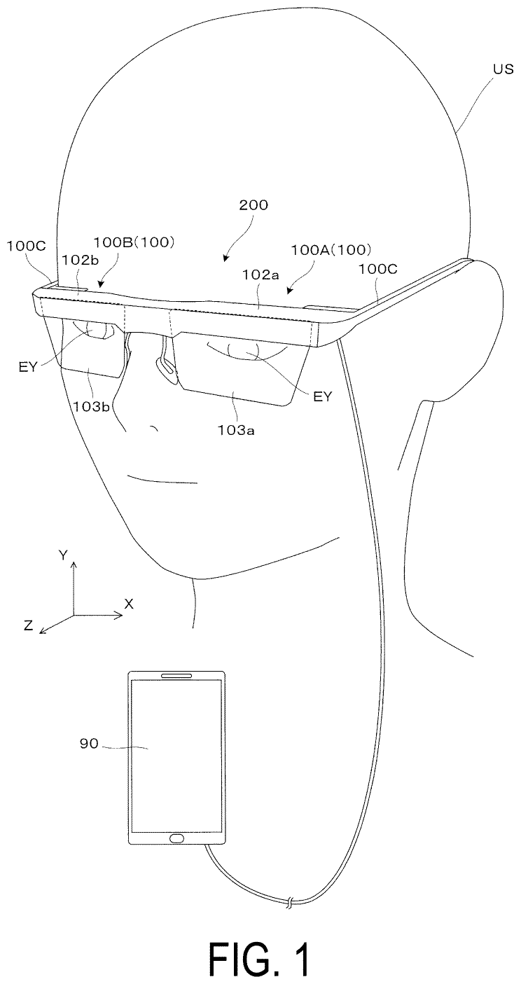

A first embodiment of a virtual image display device according to the present disclosure will be described below with reference to FIGS. 1 to 3 and the like.

FIG. 1 is a diagram for describing a mounted state of a head-mounted display apparatus (hereinafter, also referred to as a head-mounted display or an “HMD”) 200, and the HMD 200 enables an observer or wearer US, who is wearing the HMD 200, to recognize an image as a virtual image. In FIG. 1 and the like, X, Y, and Z represent a rectangular coordinate system. The +X direction corresponds to a lateral direction in which both eyes EY of the observer or the wearer US, who wears the HMD 200, are arranged. The +Y direction corresponds to the upper direction perpendicular to the lateral direction from the viewpoint of the wearer US in which both the eyes EY are arranged. The +Z direction corresponds to the forward direction or the front side direction from the viewpoint of the wearer US. The +Y direction is parallel to the vertical axis or the vertical direction. Note that the +Y direction or the upward direction corresponds to a direction from the chin of the face toward the center of the forehead in a state in which the HMD 200 is worn by the wearer US.

The HMD 200 includes a right-eye first virtual display device 100A, a left-eye second virtual display device 100B, a pair of temple type support devices 100C that support the virtual display devices 100A and 100B, and a user terminal 90 that is an information terminal. The first virtual display device 100A alone functions as an HMD, and includes a first display driving unit 102a arranged at an upper portion thereof, and a first light-guiding optical system 103a that has a spectacle lens shape and covers the front of an eye. Similarly, the second virtual display device 100B alone functions as an HMD, and includes a second display driving unit 102b arranged at an upper portion thereof, and a second light-guiding optical system 103b that has a spectacle lens shape and covers the front of an eye. The support devices 100C are mounting members mounted on a head of the wearer US, and support upper end sides of the pair of light-guiding optical systems 103a and 103b via the display driving units 102a and 102b that are integrated in appearance. The first virtual display device 100A and the second virtual display device 100B are optically left-right inverted, and a detailed description of the second virtual display device 100B will thus be omitted.

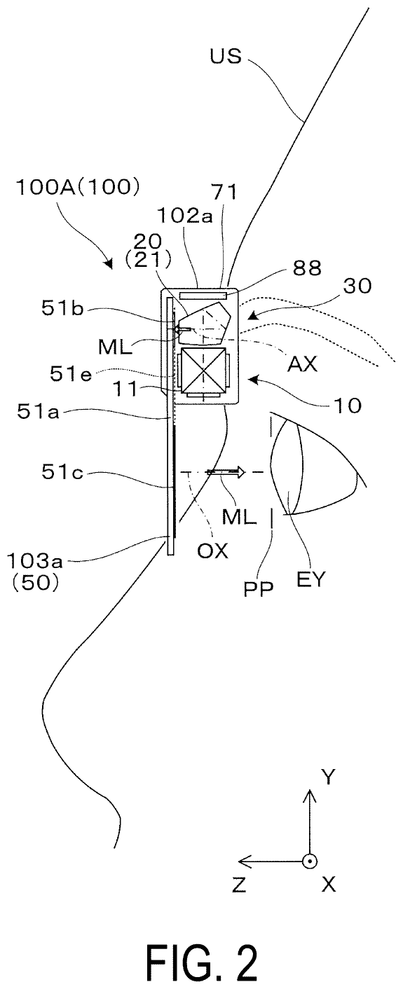

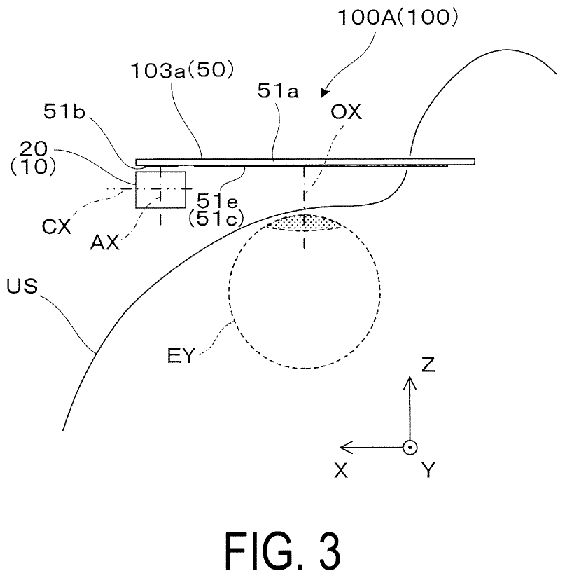

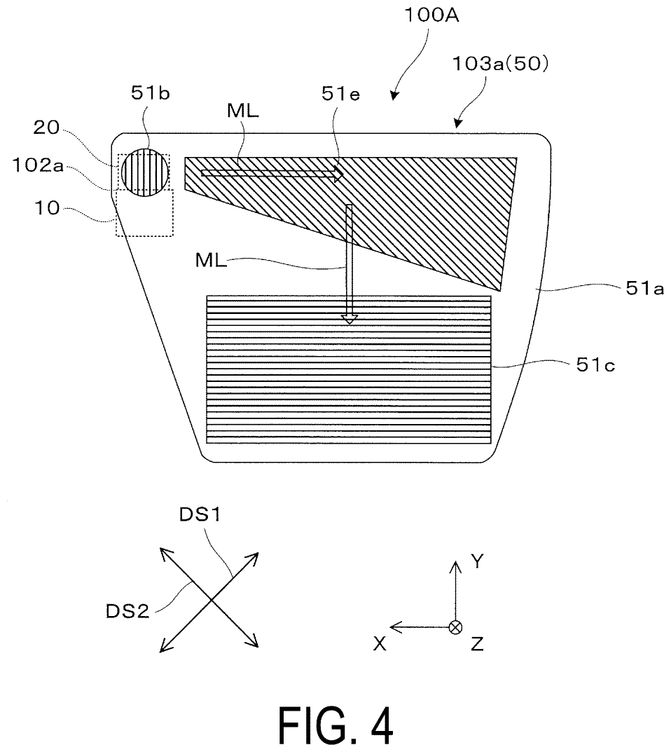

FIG. 2 is a side view for specifically describing the first display driving unit 102a and the first light-guiding optical system 103a of the first virtual image display device 103A, and FIG. 3 is a plan view for specifically describing the first display driving unit 102a and the first light-guiding optical system 103a. Further, FIG. 4 is a rear view for mainly describing the first light-guiding optical system 103a.

As illustrated in FIGS. 2 and 3, the first display driving unit 102a includes an image light generation device 10, a projection optical system 20, and a driving circuit member 88. The image light generation device 10 is an optical engine including a cross-prism type image light emission unit 11. The projection optical system 20 is a collimator including an optical path bending prism 21. Image light ML generated by the image light generation device 10 is collimated by the projection optical system 20, and is coupled to the first light-guiding optical system 103a which is the light-guiding member 50. Note that, in the first virtual image display unit 100A, an optical device excluding the driving circuit member 88 is referred to as an optical unit 100. The image unit 30 in which the image light generation device 10 and the projection optical system 20 are combined is disposed on the inner side of the first light guiding optical system 103a where the eye EY of the wearer US is located. An image unit 30 is disposed in an upper portion of the first light-guiding optical system 103a and on the side of a portion corresponding to the outer corner of the eye of the first light-guiding optical system 103a. Here, the upper portion of the first light-guiding optical system 103a means the upper side (the edge in the +Y direction) of the quadrangular shape, and the portion corresponding to the outer corner of the eye of the first light-guiding optical system 103a means the lateral outer side (the edge in the +X direction) of the quadrangular shape. As a result, the image unit 30 is disposed at a position close to a coupling portion that couples the support device 100C and the first virtual image display device 100A.

As illustrated in FIG. 4, the first light-guiding optical system 103a is a diffraction light-guiding member that enables color display of three colors of RGB and extends substantially parallel to the XY plane. The first light-guiding optical system 103a includes a light-guiding plate 51a, an incidence diffraction layer 51b, a pupil expansion grating layer 51e, and an emission diffraction layer 51c. The incidence diffraction layer 51b guides the collimated image light ML from the first display driving unit 102a into the light-guiding plate 51a to cause the image light ML to propagate in the lateral direction, the pupil expansion grating layer 51e expands the pupil size of the image light ML propagating in the lateral direction in the light-guiding plate 51a to cause the image light ML to propagate in the downward direction, and the emission diffraction layer 51c expands the pupil size of the image light ML propagating in the downward direction in the light-guiding plate 51a to emit the image light ML toward a pupil position PP (see FIG. 2) set inside the eye EY (see FIG. 2).

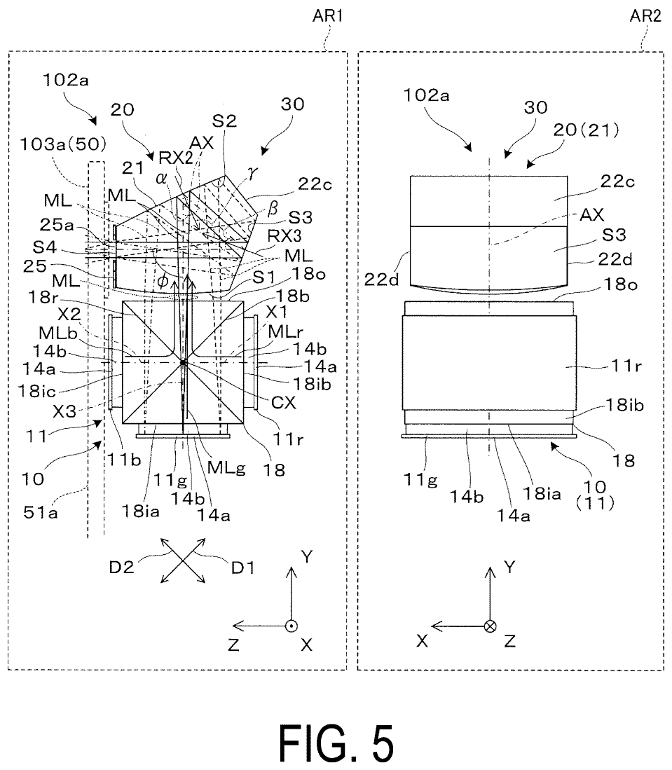

FIG. 5 is a diagram for describing an optical system of the first display driving unit 102a. In FIG. 5, an area AR1 is a side view of the optical system constituting the first display driving unit 102a, and an area AR2 is a rear view of the optical system constituting the first display driving unit 102a. In the first display driving unit 102a, the image light emission unit 11 includes three display panels 11r, 11b, and 11g and a cross dichroic prism 18. The projection optical system 20 includes an optical path bending prism 21 having positive power, and an aperture diaphragm 25. The image light emission unit 11, in which the display panels 11r, 11b, and 11g and the cross dichroic prism 18 are integrated, and the optical path bending prism 21 are supported in a state of being positioned with respect to each other by a holder 71 (see FIG. 2) that also serves as a cover, and are fixed to the first light guiding optical system 103a on the −Z side, that is, the inner side thereof. Further, the optical path bending prism 21 and the light emission unit 11 are disposed side by side in the vertical direction, and the optical path bending prism 21 is disposed above the image light emission unit 11 and the cross dichroic prism 18 that is incorporated in the image light emission unit 11.

The display panel 11r for red is a first display panel, and emits red image light MLr which is first image light. The display panel 11r is, for example, an organic electroluminescence (EL) display, forms a still image or a moving image on a two-dimensional display surface parallel to the XY plane, and emits the red image light MLr. The display panel 11r for red includes a light-emitting element 14a and a light-transmissive cover 14b. The light-emitting element 14a is constituted by a large number of pixel elements arrayed two-dimensionally along the XY plane on a substrate, and each of the pixel elements (not illustrated) has a structure similar to that of a generic organic EL element, and includes a cathode, an electron-transport layer, a light-emitting layer, a hole-transport layer, and a transparent electrode layer in this order from the substrate side.

The display panel 11b for blue is a second display panel, and emits blue image light MLb which is second image light. The display panel 11b is an organic EL display similar to the display panel 11r for red, forms a still picture or a moving picture on a two-dimensional display surface parallel to the XY plane, and emits the blue image light MLb. The display panel 11b for blue includes the light-emitting element 14a and the light-transmissive cover 14b. In the display panel 11b for blue, the light emitting element 14a is constituted by a large number of pixel elements arrayed two-dimensionally along the XY plane. The light-emitting element 14a incorporated in the display panel 11b for blue has the same structure as that of the light-emitting element 14a incorporated in the display panel 11r for red, but has a different light emission wavelength from that of the light-emitting element 14a of the display panel 11r for red.

The display panel 11g for green is a third display panel, and emits green image light MLg which is third image light. The display panel 11g is an organic EL display similar to the display panel 11r for red, forms a still picture or a moving picture on a two-dimensional display surface parallel to the XZ plane, and emits the green image light MLg. The display panel 11g for green includes the light-emitting element 14a and the light-transmissive cover 14b. In the display panel 11g for green, the light emitting element 14a is constituted by a large number of pixel elements arrayed two-dimensionally along the XZ plane. The light-emitting element 14a incorporated in the display panel 11g for green has the same structure as that of the light-emitting element 14a incorporated in the display panel 11r for red, but has a different light emission wavelength from that of the light-emitting element 14a of the display panel 11r for red.

It is assumed that a radiation angle of the red image light MLr from the pixel, a radiation angle of the blue image light MLb from the pixel, and a radiation angle of the green image light MLg from the pixel are within approximately 20°, and dichroic mirrors 18r and 18b of the cross dichroic prism 18, which will be described later, are designed based on this assumption, but the present disclosure is not limited to this example.

The light-transmissive cover 14b of the display panel 11r for red is fixed so as to be attached to a first light incident surface 18ib of the cross dichroic prism 18. The first display panel 11r for red causes the red image light MLr, which is the first image light, to be incident on the cross dichroic prism 18 from the first light incident surface 18ib. The light-transmissive cover 14b of the display panel 11b for blue is fixed so as to be attached to a second light incident surface 18ic of the cross dichroic prism 18. The second display panel 11b for blue causes the blue image light MLb, which is the second image light, to be incident on the cross dichroic prism 18 from the second light incident surface 18ic. The light-transmissive cover 14b of the display panel 11g for green is fixed so as to be attached to a third light incident surface 18ia of the cross dichroic prism 18. The third display panel 11g for green causes the green image light MLg, which is the third image light, to be incident on the cross dichroic prism 18 from the third light incident surface 18ia.

The cross dichroic prism 18 is a quadrangular column-shaped member, and has the three light incident surfaces 18ia, 18ib, and 18ic and one light emission surface 180, as side surfaces of the quadrangular column. The first light incident surface 18ib and the second light incident surface 18ic facing each other extend parallel to each other, and the third light incident surface 18ia and the light emission surface 180 facing each other extend parallel to each other. Two of the first light incident surface 18ib and the second light incident surface 18ic facing each other extend perpendicularly to the third light incident surface 18ia provided therebetween.

The cross dichroic prism 18 has a structure in which four right-angled triangular prisms 18a each formed of a glass material or the like are joined to each other so that right-angled edges thereof coincide with each other, and in which two of the dichroic mirrors 18r and 18b orthogonal to each other are each embedded in a boundary or a joining portion of the four right-angled triangular prisms 18a. The dichroic mirror 18r, which is one of the dichroic mirrors, extends perpendicularly to a reference direction D1 which is parallel to the YZ plane and forms 45° with respect to the Y direction and the −Z direction. That is, the dichroic mirror 18r is disposed at an angle of 45° with respect to the first incident surface 18ib. The dichroic mirror 18r forms a surface connecting diagonal corners of a square contour of the cross dichroic prism 18 when viewed from a direction of an intersecting axis CX of the cross dichroic prism 18. The dichroic mirror 18b, which is the other of the dichroic mirrors, extends perpendicularly to a reference direction D2 that is perpendicular to the reference direction D1, with reference to the reference direction D1 which is parallel to the YZ plane and forms 45° with respect to the Y direction and the −Z direction. That is, the dichroic mirror 18b is disposed at an angle of 45° with respect to the second incident surface 18ic. The dichroic mirror 18b forms a surface connecting diagonal corners of the square outline of the cross dichroic prism 18 when viewed from the direction of the intersecting axis CX of the cross dichroic prism 18.

The red image light MLr incident on the first incident surface 18ib of the cross dichroic prism 18 from the first display panel 11r for red is reflected by the dichroic mirror 18r, bent to the emission side, that is, an optical axis AX side, and emitted from the light emission surface 180 to the outside in the +Y direction. The blue image light MLb incident on the second incident surface 18ic of the cross dichroic prism 18 from the second display panel 11b for blue is reflected by the dichroic mirror 18b, bent to the emission side, that is, the optical axis AX side, and emitted from the light emission surface 180 to the outside in the +Y direction. The green image light MLg incident on the third incident surface 18ia of the cross dichroic prism 18 from the third display panel 11g for green passes through to the optical axis AX side without being reflected by the dichroic mirrors 18r and 18b, and is emitted from the light emission surface 180 to the outside in the +Y direction. That is, the cross dichroic prism 18 transmits the green image light MLg. As a result, an image in which the red image light MLr, the green image light MLg, and the blue image light MLb are superimposed is synthesized by the cross dichroic prism 18, is emitted as the image light ML, and can be caused to be incident on the projection optical system 20.

In the cross dichroic prism 18, the intersecting axis CX extends along an intersection line of the two dichroic mirrors 18r and 18b, and is parallel to the X direction. A first optical axis X1 extending from the center of the first display panel 11r for red to the cross dichroic prism 18 is parallel to the Z direction. A second optical axis X2 extending from the center of the blue display panel 11b to the cross dichroic prism 18 is parallel to the Z direction. A third optical axis X3 extending from the center of the green display panel 11g to the cross dichroic prism 18 is parallel to the Y direction. The optical axis AX extending from the center of the intersecting axis CX to the light emission surface 180 of the cross dichroic prism 18 is an extension of the third optical axis X3 and extends parallel to the Y direction.

In the configuration described above, the optical axis AX passing through the light emission surface 180 of the cross dichroic prism 18 extends in the vertical direction parallel to the light-guiding plate 51a, that is, in the Y direction. As a result, the projection optical system 20 including the optical path bending prism 21, and the cross dichroic prism 18 can be arranged along the light-guiding plate 51a, and the height of the optical system protruding from the light-guiding plate 51a can be reduced. Further, the intersecting axis CX of the cross dichroic prism 18 extends parallel to the light-guiding plate 51a. In this case, since each of the display panels 11r, 11b, and 11g has a horizontally long aspect ratio and has a relatively large size in the X direction parallel to the intersecting axes CX, the cross-sectional size of the cross dichroic prism 18 viewed from the X direction can be reduced, and the cross dichroic prism 18 can be easily brought closer to the light-guiding plate 51a.

The optical path bending prism 21 of the projection optical system 20 is an optical member having a refractive reflection function that is a mixture of a mirror function and a lens function, and reflects the image light ML from the cross dichroic prism 18 of the image light emission unit 11 while refracting it. The optical path bending prism 21 has, as optical surfaces, a first transmission surface S1 which is a convex refracting surface, a first reflection surface S2 which is a concave reflection surface, a second reflection surface S3 which is a concave reflection surface, and a second transmission surface S4 which is a flat refracting surface. The aperture diaphragm 25 is auxiliarily provided at the second transmission surface S4.

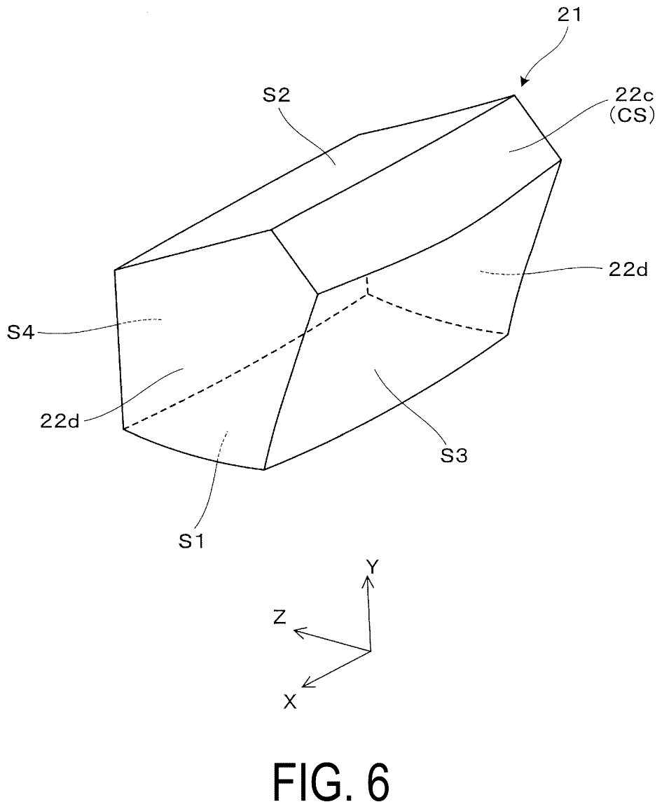

FIG. 6 is a perspective view illustrating an external appearance of the optical path bending prism 21. The optical path bending prism 21 has an outer shape of a pentagonal column shape that is long in the X direction. In the optical path bending prism 21, an inclined surface 22c connecting the first reflection surface S2 and the second reflection surface S3 is a connecting surface CS that does not optically function, and may be a flat surface or a curved surface. The optical path bending prism 21 has a pair of side surfaces 22d at both ends in the lateral direction. The optical path bending prism 21 has a relatively horizontally long outline corresponding to the aspect ratio of the display panels 11r, 11b, 11g.

Returning to FIG. 5, the optical path bending prism 21 emits the image light ML incident from the lower side where the image light emission unit 11 is disposed, so that the image light ML is bent back in the forward direction. The first transmission surface S1, the first reflection surface S2, and the second reflection surface S3 constituting the optical path bending prism 21 have positive power. Each of the first transmission surface S1 and the first reflection surface S2, and the second reflection surface S3 has asymmetry across the optical axis AX in the longitudinal direction that is parallel to the YZ plane and intersects the optical axis AX, and has symmetry across the optical axis AX in the lateral direction or the X direction. The first transmission surface S1, the first reflection surface S2, and the second reflection surface S3 are, for example, free-form surfaces. Each of the first transmission surface S1 and the first reflection surface S2, and the second reflection surface S3 is not limited to the free form surface, and may be an aspherical surface. The optical path bending prism 21 is made of glass or a resin. The first reflection surface S2 and the second reflection surface S3 can be configured to reflect the image light ML by total reflection, but can also be each formed as a reflection surface formed of a metal film or a dielectric multilayer film. In this case, a reflection film formed of a single layer film or a multilayer film formed of a metal such as Al or Ag is formed on the first reflection surface S2 and the second reflection surface S3 by vapor deposition or the like. Although detailed illustration is omitted, an anti-reflection film can be formed on the first transmission surface S1 and the second transmission surface S4.

Each of the reflection surfaces S2 and S3 may be a structural reflection surface such as a wire grid, or may be a reflective polarizing film. As the structural reflection surface, for example, a wire grid polarizer in which a fine wire grid structure made of aluminum is formed on a resin film substrate can be used. The reflective polarizing film is obtained by forming a polarization separation film having a multilayer structure on a resin film substrate. That is, the reflection surface of the optical path bending prism 21 may have various structures such as a structure in which a plurality of metal films or dielectrics are layered, and a structure having a fine structure on the surface.

The optical axis AX passing through the second transmission surface S4 of the optical path bending prism 21 is an optical axis on the emission side of the projection optical system 20 and extends perpendicularly to the light-guiding plate 51a. Further, the optical axis AX passing through the first transmission surface S1 of the optical path bending prism 21 and the optical axis AX passing through the second transmission surface S4 of the optical path bending prism 21 are perpendicular and orthogonal to each other. In this case, the optical path is bent by 90° when passing through the optical path bending prism 21, and the cross dichroic prism 18 can be disposed along the light-guiding plate 51a. The optical axis AX on the incidence side passing through the first transmission surface S1 of the optical path bending prism 21 and the optical axis AX on the emission side passing through the second transmission surface S4 can be brought into a state other than the orthogonal state by adjusting an angular relationship with the first reflection surface S2, the second reflection surface S3, and the like. When an angle φ between the optical axis AX passing through the first transmission surface S1 and the optical axis AX passing through the second transmission surface S4 is, for example, an obtuse angle, the cross dichroic prism 18 is located at a position displaced from the optical path bending prism 21 in the −Z direction and disposed relatively away from the light-guiding plate 51a, so that the distance from the light-guiding plate 51a can be adjusted. As described above, since the optical path bending prism 21 not only bends and substantially shortens the optical path but also functions like a joint with respect to the optical path, the degree of freedom of the arrangement of the cross dichroic prism 18 can be increased.

In the optical path bending prism 21, when an angle formed by the optical axis AX before and after the light is reflected by the first reflection surface S2 is α, and an angle formed by the optical axis AX before and after the light is reflected by the second reflection surface S3 is β, the angle α and the angle β are substantially equal to each other in order to prevent aberration correction from becoming difficult due to the optical axis AX becoming excessively off-axial. Further, a reference axis RX2 of the first reflection surface S2 corresponding to a bisector of the optical axis AX before and after reflection by the first reflection surface S2 and a reference axis RX3 of the second reflection surface S3 corresponding to a bisector of the optical axis AX before and after reflection by the second reflection surface S3 form an obtuse angle γ with respect to the inward direction. This means that the first reflection surface S2 and the second reflection surface S3 are disposed in a state of facing each other at an acute angle rather than being orthogonal to each other as a whole, and the optical axis AX incident on the first reflection surface S2 and the optical axis AX emitted from the second reflection surface S3 can intersect each other.

The optical path bending prism 21 is an optical system that is substantially telecentric with respect to the image light emission unit 11 side, which is an object side. That is, main beams of the image lights MLg, MLr, and MLb emitted from respective portions of the display surfaces of the respective display panels 11b, 11r, and 11g pass through the cross dichroic prism 18 via the light incident surfaces 18ib, 18ic, and 18ia in a state of being substantially parallel to the optical axes X1, X2, and X3, and are emitted from the cross dichroic prism 18 in a state of being substantially parallel to the optical axis AX. As a result, the red image light MLr, the green image light MLg, and the blue image light MLb in a predetermined angle range or less are incident on the dichroic mirrors 18r and 18b, and it is possible to suppress light loss due to the dichroic mirrors 18r and 18b.

The optical path bending prism 21 causes the image lights MLg, MLr, and MLb emitted from the display surfaces of the respective display panels 11b, 11r, and 11g to be incident on and collected in a central region of the incidence diffraction layer 51b of the light-guiding plate 51 while collimating the image lights MLg, MLr, and MLb. At this time, the image lights MLg, MLr, and MLb pass through an aperture 25a of the aperture diaphragm 25. The aperture diaphragm 25 suppresses generation of stray light.

Returning to FIG. 4, in the first light-guiding optical system 103a or the light-guiding member 50, the incidence diffraction layer 51b is a first diffraction element and is formed with a diffraction pattern that extends linearly in the vertical Y direction and repeats periodically in the horizontal X direction. The emission diffraction layer 51c is a second diffraction element and is formed with a diffraction pattern that extends linearly in the horizontal X direction and repeats periodically in the vertical Y direction. The pupil expansion grating layer 51e is a third diffraction element, is provided on the +X side of the incidence diffraction layer 51b, and bends the optical path so that the image light ML, which is guided into the light-guiding plate 51a and advances in the +X direction as a whole, advances in the −Y direction as a whole.

The incidence diffraction layer 51b, the emission diffraction layer 51c, and the pupil expansion grating layer 51e diffract the image lights MLg, MLr, and MLb in accordance with the wavelengths thereof, and are formed of, for example, surface-relief diffraction elements. The surface-relief-type diffraction element is formed by nano-imprinting, but is not limited thereto, and may be formed by etching the surface of the light-guiding plate 51a, or may be formed by attaching a diffraction element to the surface. The incidence diffraction layer 51b, the emission diffraction layer 51c, and the pupil expansion grating layer 51e may be each formed from a volumetric hologram. The incidence diffraction layer 51b, the emission diffraction layer 51c, and the pupil expansion grating layer 51e are not limited to being formed of a single layer, and may be formed by layering a plurality of functional layers adapted to the wavelength and the viewing angle direction of the image light ML. The light-guiding plate 51a is formed of plastic or glass. When the light-guiding plate 51a is formed of plastic, the light-guiding plate 51a may have a thickness of, for example, approximately 1 mm, and when the light-guiding plate 51a is formed of glass, the light-guiding plate 51a may have a thickness of, for example, approximately 0.3 mm to 0.4 mm.

The pupil expansion grating layer 51e is configured not to substantially impair angle information regarding the left-right X direction of the image light ML and angle information regarding the up-down Y direction of the image light ML, while changing the diffraction direction. The pupil expansion grating layer 51e is interposed between the incidence diffraction layer 51b and the emission diffraction layer 51c. The pupil expansion grating layer 51e divides the light beam while guiding the image light ML in a direction (−Y direction) intersecting the diffraction direction (−X direction) of the incidence diffraction layer 51b, and has a function of expanding the light beam width in the lateral direction. The pupil expansion grating layer 51e is formed with a diffraction pattern that extends linearly in an oblique direction DS2 parallel to the XY plane and repeats periodically in a direction DS1 parallel to the XY plane and perpendicular to the direction DS2. The direction DS1 is a direction rotated clockwise by 45° with respect to the +Y direction, and is an intermediate direction between the −X direction and the +Y direction. The grating period or the pitch in the X direction and the Y direction of the pattern formed on the pupil expansion grating layer 51e matches with the grating period in the X direction of the pattern formed on the incidence diffraction layer 51b and the grating period in the Y direction of the pattern formed on the emission diffraction layer 51c. The emission diffraction layer 51c divides the light beam while guiding the image light ML in the −Y direction, and has a function of expanding the light beam width in the vertical direction. As a result, the light beam width in the X direction and the Y direction of the image light ML incident on the pupil position PP illustrated in FIG. 2 has a spread corresponding to the emission diffraction layer 51c, and the pupil size in the vertical direction and the horizontal direction increases via the pupil expansion grating layer 51e, the emission diffraction layer 51c, and the like. The image light ML collimated around an emission optical axis OX (see FIG. 2) perpendicular to the light-guiding plate 51a is emitted from the emission diffraction layer 51c. The image light ML emitted from the emission diffraction layer 51c is within a range of approximately ±25° with respect to the emission optical axis OX. That is, the angle of view of the first virtual image display device 100A is approximately 50°.

In the above description, the optical axis AX passing through the light emission surface 180 of the cross dichroic prism 18 extends in the vertical Y direction, but the optical axis AX passing through the light emission surface 180 may extend in the horizontal X direction. In this case, the optical path bending prism 21 and the cross dichroic prism 18 are arranged in the horizontal X direction along the light-guiding plate 51a.

In the above description, the optical axis AX passing through the second transmission surface S4 of the optical path bending prism 21 extends perpendicularly to the light-guiding plate 51a, but the optical axis AX emitted from the optical path bending prism 21 can be inclined from the state perpendicular to the light-guiding plate 51a. For example, by adjusting the angular relationship between the second reflection surface S3 and the second transmission surface S4 constituting the optical path bending prism 21 illustrated in FIG. 6 and the like, the direction of the optical axis AX emitted from the second transmission surface S4 can be adjusted so as to be inclined in a desired direction and at a desired angle with respect to the normal direction of the optical axis AX.

Each of the display panels 11b, 11r, and 11g is not limited to the organic EL display panel, and can be replaced with a display device using LED array, laser array, a quantum-dot self-emitting type element, or the like.

A polarizing plate or a filter may be interposed between the transmissive cover 14b of the display panel 11b, 11r, 11g and the light incident surface 18ib, 18ic, 18ia of the cross dichroic prism 18.

The light-guiding plate 51a or the incidence diffraction layer 51b and the second transmission surface S4 of the optical path bending prism 21 do not need to be separated from each other, and they can be brought into close contact with each other.

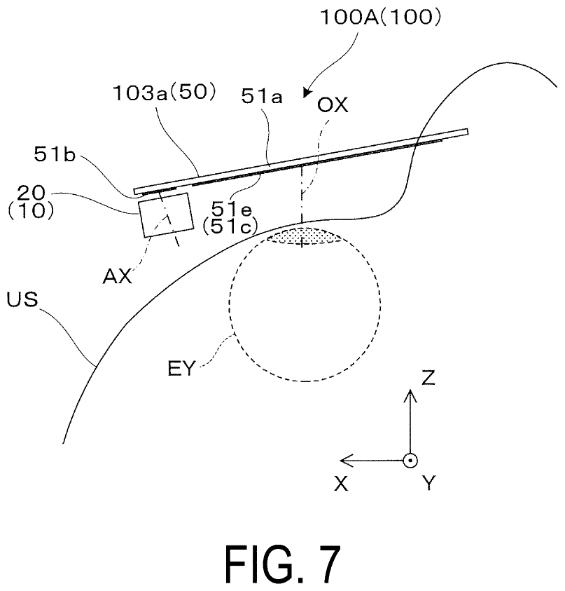

In a modified example illustrated in FIG. 7, by adjusting the shape of the optical path bending prism 21, the optical axis AX emitted from the projection optical system 20 is inclined toward the nose side or the −X side on the projection optical system 20 side or on the upstream side, with respect to the state perpendicular to the light-guiding plate 51a. As a result, the emission optical axis OX can be inclined toward the ear side or the +X side on the pupil side, and the light-guiding plate 51a can be rotated counterclockwise and inclined with respect to the vertical Y-axis, so that the light-guiding plate 51a can be arranged to fit the face. As illustrated in FIG. 7, in order to cause the optical axis AX emitted from the projection optical system 20 to be inclined when viewed from the Y-axis direction or from above, the optical unit 100 or the image unit 30 is integrally rotated about an axis parallel to the Y-axis.

Each of the virtual image display devices 100A and 100B according to the first embodiment includes the first display panel 11r that emits the red image light MLr as the first image light, the second display panel 11b that emits the blue image light MLb as the second image light, the third display panel 11g that emits the green image light MLg as the third image light, and the cross dichroic prism 18 that has the first light incident surface 18ib on which the red image light MLr that is the first image light is incident, the second light incident surface 18ic on which the blue image light MLb that is the second image light is incident, the third incident surface 18ia on which the green image light MLg that is the third image light is incident, that synthesizes the first image light, the second image light, and the third image light, and that emits the synthesized image light ML from the light emission surface. Each of the virtual image display devices 100A and 100B further includes the projection optical system 20 that includes the optical path bending prism 21 having the first transmission surface S1 on which the image light ML from the cross dichroic prism 18 is incident, the first reflection surface S2 that reflects the image light ML transmitted through the first transmission surface, the second reflection surface S3 that reflects the image light ML reflected by the first reflection surface S2, and the second transmission surface S4 that emits the image light ML reflected by the second reflection surface S3. Further, the virtual image display devices 100A and 100B include the light-guiding optical systems 103a and 103b that are the light-guiding members 50 that guide the image light ML emitted from the projection optical system 20 to the pupil position PP at which the eye is located, respectively.

In each of the virtual image display devices 100A and 100B, since the optical path bending prism 21 included in the projection optical system 20 has the first transmission surface S1 on which the image light ML from the cross dichroic prism 18 is incident, the first reflection surface S2 that reflects the image light ML transmitted through the first transmission surface S1, the second reflection surface S3 that reflects the image light ML reflected by the first reflection surface S2, and the second transmission surface S4 that emits the image light ML reflected by the second reflection surface S3, the optical path is bent inside the optical path bending prism 21, and the optical path can be extended. Thus, the imaging performance is easily enhanced. Further, since the optical axis AX incident on the optical path bending prism 21 and the optical axis AX emitted from the optical path bending prism 21 can be caused to have a desired angular difference, the degree of freedom in the arrangement of the cross dichroic prism 18 is increased, and thus the optical system as a whole can be downsized.

### Second Embodiment

A virtual image display device according to a second embodiment of the present disclosure will be described below. Note that the virtual image display device according to the second embodiment is a partial modification of the virtual image display device according to the first embodiment, and thus description of common parts will be omitted.

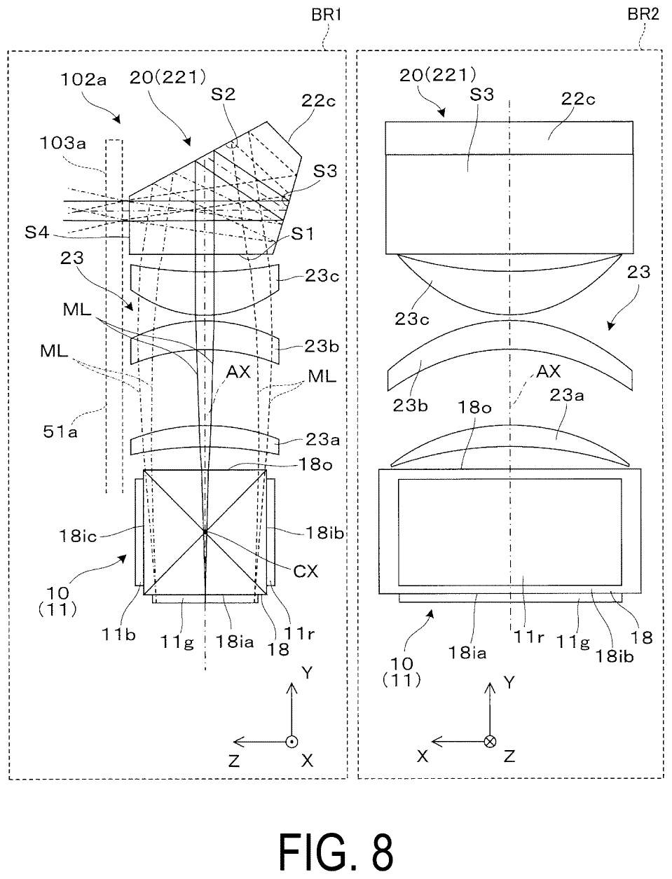

FIG. 8 is a diagram for describing the virtual image display device according to the second embodiment. In FIG. 8, a region BR1 is a side view of an optical system constituting the first display driving unit 102a, and a region BR2 is a rear view of the optical system constituting the first display driving unit 102a.

As illustrated in FIG. 8, in the virtual image display device according to the second embodiment, the projection optical system 20 of the first display driving unit 102a includes an optical path bending prism 221 having no power and a lens group 23. The optical path bending prism 221 has, as optical surfaces, the first transmission surface S1 that is a planar refraction surface, the first reflection surface S2 that is a planar reflection surface, the second reflection surface S3 that is a planar reflection surface, and the second transmission surface S4 that is a planar refraction surface. Further, the lens group 23 has positive power as a whole, and includes a first lens 23a, a second lens 23b, and a third lens 23c. Each of the lenses 23a, 23b, and 23c has positive power. The angular relationships between the surfaces S1, S2, S3, and S4 are not limited to those illustrated in FIG. 8 and can be changed. As a result, the direction of the optical axis AX passing through the light emission surface 180 of the cross dichroic prism 18 can be freely adjusted with respect to the light-guiding plate 51a, and a direction in which the cross dichroic prism 18 protrudes from the light-guiding plate 51a can be freely adjusted.

Note that the number of lenses constituting the lens group 23 is not limited to three, but may be one, two, or four or more.

### Third Embodiment

A virtual image display device according to a third embodiment of the present disclosure will be described below. Note that the virtual image display device according to the third embodiment is a partial modification of the virtual image display device according to the first embodiment, and thus description of common parts will be omitted.

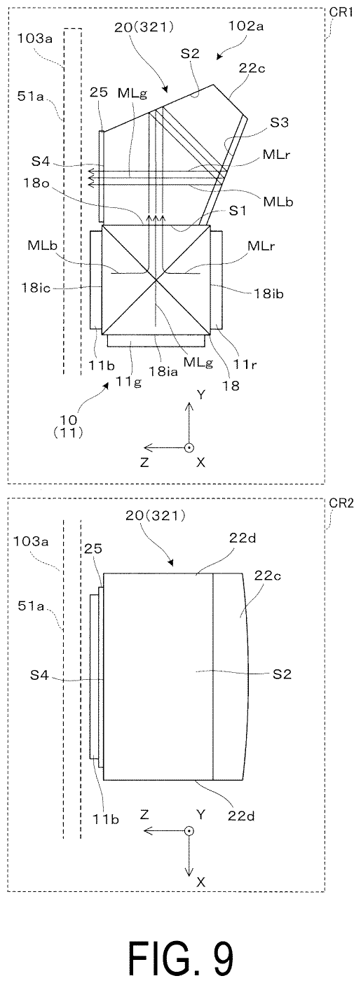

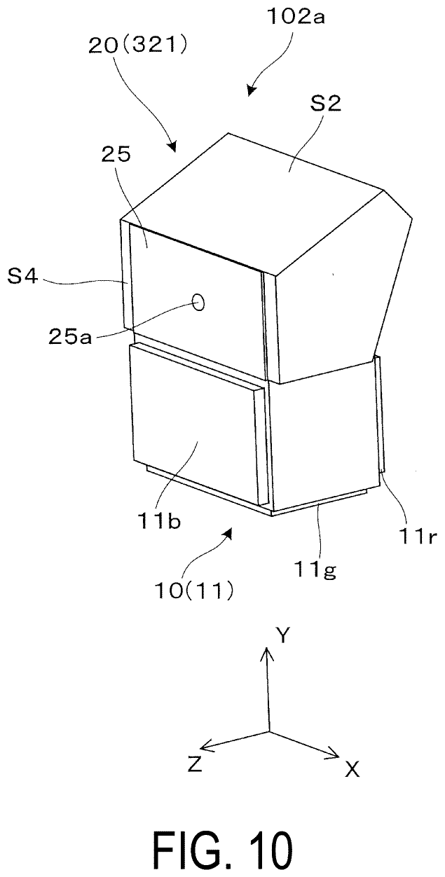

FIG. 9 is a diagram for describing the virtual image display device according to the third embodiment. In FIG. 9, a region CR1 is a side view of an optical system constituting the first display driving unit 102a, and a region CR2 is a plan view of the optical system constituting the first display driving unit 102a. FIG. 10 is a perspective view of the optical system constituting the first display driving unit 102a.

As illustrated in FIGS. 9 and 10, in the virtual image display device according to the third embodiment, the projection optical system 20 of the first display driving unit 102a includes only an optical path bending prism 321 having positive power. The optical path bending prism 321 has, as optical surfaces, the first transmission surface S1 that is a planar refraction surface, the first reflection surface S2 that is a concave reflection surface, the second reflection surface S3 that is a concave reflection surface, and the second transmission surface S4 that is a planar refraction surface. Here, the first reflection surface S2 and the second reflection surface S3 have positive power. The first transmission surface S1 of the optical path bending prism 321 is a flat surface and is bonded to the light emission surface 180 of the cross dichroic prism 18. That is, the cross dichroic prism 18 and the optical path bending prism 321 are integrated and can be treated as one block. Further, by bringing the first transmission surface S1 and the light emission surface 180 into contact with each other, the optical path bending prism 321 can be positioned with respect to the cross dichroic prism 18 in terms of rotation about the X-axis and rotation about the Z-axis, and can be fixed with high accuracy. Thus, downsizing and improvement in accuracy of the first display driving unit 102a are easily achieved.

In the case of this embodiment, the image light ML passing from the cross dichroic prism 18 to the optical path bending prism 321 is likely to be generated. Thus, when a divergence angle component of the image light ML from each of the pixels is large, it may be preferable to separate the second transmission surface S4 of the optical path bending prism 321 from the light-guiding plate 51a or the incidence diffraction layer 51b.

### Others

The structures described above are examples and various modifications can be made without departing from the scope capable of achieving the same functions.

The optical path bending prism 21 is not limited to the one having the first transmission surface S1 on which the image light ML is incident, the first reflection surface S2 that reflects the image light ML transmitted through the first transmission surface S1, the second reflection surface S3 that reflects the image light ML reflected by the first reflection surface S2, and the second transmission surface S4 that emits the image light ML reflected by the second reflection surface S3, but may be an optical path bending prism having a third reflection surface that causes the image light ML reflected by the first reflection surface S2 to be incident on the second reflection surface S3.

The aperture diaphragm 25 auxiliarily provided at the second transmission surface S4, which is the emission surface of the optical path bending prism 21, is not essential.

By slightly shifting the arrangement of the display panels 11b, 11r, and 11g in the vertical and horizontal directions, the emission pupil of the optical path bending prism 21 can be arranged differently for each color. In this case, in the aperture diaphragm 25, a plurality of the apertures 25a suitable for each color can be provided while being shifted in the X direction or the Y direction. In this case, the incidence diffraction layer 51b can be provided for each of the apertures 25a for each color, or can be provided so as to cover the entire aperture 25a. The light-guiding member 50 may be formed by stacking a plurality of light-guiding plates or light guides in parallel. For example, it is conceivable that a first light-guiding plate is used for RG and a second light-guiding plate is used for BG. In this case, in each of the first light-guiding plate and the second light-guiding plate, a region of the incidence diffraction layer is provided so as to face the aperture 25a for the G color.

When the angle φ formed by the optical axis AX passing through the first transmission surface S1 of the optical path bending prism 21 and the optical axis AX passing through the second transmission surface S4 of the optical path bending prism 21 is an obtuse angle, the cross dichroic prism 18 tends to protrude more than the optical path bending prism 21 with respect to the light-guiding plate 51a, but a space for accommodating the display panels 11b, 11r, and 11g and auxiliary driving circuits thereof can be easily secured.

The light-guiding member 50 is not limited to the one including the incidence diffraction layer 51b, the emission diffraction layer 51c, and the pupil expansion grating layer 51e. For example, the pupil expansion grating layer 51e can be omitted. In this case, the collimated image light ML is guided into the light-guiding plate 51a by the incidence diffraction layer 51b, propagated in the lateral direction, and emitted by the emission diffraction layer 51c toward the pupil position PP on the inner side of the image light ML propagated in the lateral direction inside the light-guiding plate 51a.

The light-guiding member 50 may be formed by stacking a plurality of light guides in parallel. In this case, each of the light guides constituting the light-guiding member 50 may correspond to three colors of RBG, for example. Each of the light guides includes the light-guiding plate 51a, the incidence diffraction layer 51b, the emission diffraction layer 51c, and the pupil expansion grating layer 51e.

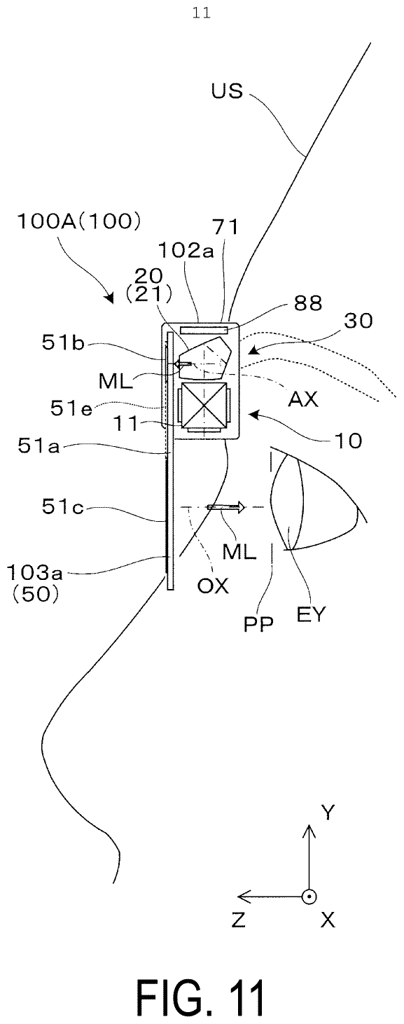

As illustrated in FIG. 11, the light-guiding member 50 may be provided with the incidence diffraction layer 51b, the emission diffraction layer 51c, and the pupil expansion grating layer 51e on the outer world side of the light-guiding plate 51e. In this case, the incidence diffraction layer 51b, the emission diffraction layer 51c, and the pupil expansion grating layer 51e are all reflective diffraction elements.

Of the optical surfaces constituting the optical path bending prism 221 illustrated in FIG. 8, for example, the first transmission surface S1 may be a convex refraction surface, or the first reflection surface S2, the second reflection surface S3, and the like may be concave reflection surfaces.

In the first display drive unit 102a, the optical system in which the cross dichroic prism 18 and the optical path bending prism 21 are combined is not limited to the optical system in which the image light ML is coupled to the first light-guiding optical system 103a, which is a diffraction light-guiding member, but may be an optical system in which the image light ML is coupled to various non-diffraction light-guiding plates, or an optical system in which the image light ML is coupled to a Birdbath type light-guiding member. For example, as one form of the various non-diffraction light-guiding plates, the image light ML can be coupled by providing a region in which a large number of divided mirrors are embedded, in a single light-guiding plate at a position corresponding to a diffraction element.

Although it has been described above that the virtual image display devices 100A and 100B can be used as an HMD, the present disclosure is not limited thereto and can be applied to various optical devices, for example, a head-up display (HUD).

A virtual image display device according to a specific aspect includes a first display panel configured to emit first image light, a second display panel configured to emit second image light having a wavelength region different from a wavelength region of the first image light, a third display panel configured to emit third image light having a wavelength region different from the wavelength regions of the first image light and the second image light, a cross dichroic prism including a first light incident surface on which the first image light is incident, a second light incident surface on which the second image light is incident, and a third light incident surface on which the third image light is incident, and configured to synthesize the first image light, the second image light, and the third image light and emit the synthesized image light from a light emission surface, a projection optical system including an optical path bending prism having a first transmission surface on which the image light from the cross dichroic prism is incident, a first reflection surface and a second reflection surface that reflect the image light transmitted through the first transmission surface, and a second transmission surface that emits the image light reflected by the second reflection surface, and a light-guiding member configured to guide the image light emitted from the projection optical system to a pupil position at which an eye is located.

In the virtual image display device described above, since the optical path bending prism included in the projection optical system has the first transmission surface on which the image light from the cross dichroic prism is incident, the first reflection surface that reflects the image light transmitted through the first transmission surface, the second reflection surface that reflects the image light reflected by the first reflection surface, and the second transmission surface that emits the image light reflected by the second reflection surface, the optical path is bent inside the optical path bending prism, and the optical path can be extended. Thus, the imaging performance is easily enhanced. Further, since the optical axis incident on the optical path bending prism and the optical axis emitted from the optical path bending prism can be caused to have a desired angular difference, the degree of freedom in the arrangement of the cross dichroic prism is increased, and thus the optical system as a whole can be downsized.

In the virtual image display device according to the specific aspect, the optical path bending prism has positive power. In this case, the optical path bending prism contributes to formation as part of a collimator, and this makes it easy to reduce the number of optical members constituting the projection optical system.

In the virtual image display device according to the specific aspect, the first reflection surface has positive power.

In the virtual image display device according to the specific aspect, the second reflection surface has positive power. In this case, it is possible to reduce necessity of incorporating a lens in the projection optical system.

In the virtual image display device according to the specific aspect, the first transmission surface has positive power. In this case, it is possible to reduce necessity of incorporating a lens in the projection optical system.

In the virtual image display device according to the specific aspect, the first transmission surface is a flat surface and is bonded to the light emission surface of the cross dichroic prism. In this case, positioning of the cross dichroic prism and the optical path bending prism becomes easy.

In the virtual image display device according to the specific aspect, the projection optical system includes a lens disposed between the cross dichroic prism and the optical path bending prism.

In the virtual image display device according to the specific aspect, an optical axis passing through the first transmission surface of the optical path bending prism and an optical axis passing through the second transmission surface of the optical path bending prism form a right angle or an obtuse angle. In this case, the optical path can be bent appropriately when passing through the optical path bending prism, and the cross dichroic prism is easily disposed so as to be closer to the light-guiding member.

In the virtual image display device according to the specific aspect, the light-guiding member includes a light-guiding plate having a flat plate shape, an incidence diffraction layer auxiliarily provided at the light-guiding plate, and an emission diffraction layer auxiliarily provided at the light-guiding plate at a position different from a position of the incidence diffraction layer. In this case, the pupil can be expanded while the light-guiding member causes the image light to propagate from the incidence diffraction layer to the emission diffraction layer.

In the virtual image display device according to the specific aspect, an optical axis on an emission side of the projection optical system extends perpendicularly to the light-guiding plate.

In the virtual image display device according to the specific aspect, an optical axis passing through the light emission surface of the cross dichroic prism extends parallel to the light-guiding plate. In this case, the optical path bending prism and the cross dichroic prism can be disposed along the light-guiding plate, and the height of the optical system protruding from the light-guiding plate can be reduced.

In the virtual image display device according to the specific aspect, the optical path bending prism is disposed above the cross dichroic prism.

In the virtual image display device according to the specific aspect, an intersecting axis of the cross dichroic prism extends parallel to the light-guiding plate. In this case, when the aspect ratio of the display panel is large with respect to a direction parallel to the intersecting axis, the cross dichroic prism is easily caused to be closer to the light-guiding plate.

In the virtual image display device according to the specific aspect, an aperture diaphragm is auxiliarily provided at the second transmission surface of the optical path bending prism. In this case, generation of stray light is easily suppressed.

An optical unit according to a specific aspect includes a first display panel configured to emit first image light, a second display panel configured to emit second image light having a wavelength region different from a wavelength region of the first image light, a third display panel configured to emit third image light having a wavelength region different from the wavelength regions of the first image light and the second image light, a cross dichroic prism including a first light incident surface on which the first image light is incident, a second light incident surface on which the second image light is incident, and a third light incident surface on which the third image light is incident, and configured to synthesize the first image light, the second image light, and the third image light and emit the synthesized image light from a light emission surface, a projection optical system including an optical path bending prism having a first transmission surface on which the image light from the cross dichroic prism is incident, a first reflection surface and a second reflection surface that reflect the image light transmitted through the first transmission surface, and a second transmission surface that emits the image light reflected by the second reflection surface, and a light-guiding member configured to guide the image light emitted from the projection optical system to a pupil position at which an eye is located.

What is claimed is:

1. A virtual image display device comprising:
a first display panel configured to emit first image light;
a second display panel configured to emit second image light having a wavelength region different from a wavelength region of the first image light;
a third display panel configured to emit third image light having a wavelength region different from the wavelength regions of the first image light and the second image light;
a cross dichroic prism including a first light incident surface on which the first image light is incident, a second light incident surface on which the second image light is incident, and a third light incident surface on which the third image light is incident, and configured to synthesize the first image light, the second image light, and the third image light and emit the synthesized image light from a light emission surface;
a projection optical system including an optical path bending prism having a first transmission surface on which the image light from the cross dichroic prism is incident, a first reflection surface and a second reflection surface that reflect the image light transmitted through the first transmission surface, and a second transmission surface that emits the image light reflected by the second reflection surface; and
a light-guiding member configured to guide the image light emitted from the projection optical system to a pupil position at which an eye is located.

2. The virtual image display device according to claim 1, wherein
the optical path bending prism has positive power.

3. The virtual image display device according to claim 2, wherein
the first reflection surface has positive power.

4. The virtual image display device according to claim 3, wherein
the second reflection surface has positive power.

5. The virtual image display device according to claim 2, wherein
the first transmission surface has positive power.

6. The virtual image display device according to claim 2, wherein
the first transmission surface is a flat surface and is bonded to the light emission surface of the cross dichroic prism.

7. The virtual image display device according to claim 1, wherein
the projection optical system includes a lens disposed between the cross dichroic prism and the optical path bending prism.

8. The virtual image display device according to claim 1, wherein
an optical axis passing through the first transmission surface of the optical path bending prism and an optical axis passing through the second transmission surface of the optical path bending prism form a right angle or an obtuse angle.

9. The virtual image display device according to claim 1, wherein
the light-guiding member includes a light-guiding plate having a flat plate shape, an incidence diffraction layer auxiliarily provided at the light-guiding plate, and an emission diffraction layer auxiliarily provided at the light-guiding plate at a position different from a position of the incidence diffraction layer.

10. The virtual image display device according to claim 9, wherein
an optical axis on an emission side of the projection optical system extends perpendicularly to the light-guiding plate.

11. The virtual image display device according to claim 10, wherein
an optical axis passing through the light emission surface of the cross dichroic prism extends parallel to the light-guiding plate.

12. The virtual image display device according to claim 11, wherein
the optical path bending prism is disposed above the cross dichroic prism.

13. The virtual image display device according to claim 11, wherein
an intersecting axis of the cross dichroic prism extends parallel to the light-guiding plate.

14. The virtual image display device according to claim 1, wherein
an aperture diaphragm is auxiliarily provided at the second transmission surface of the optical path bending prism.

15. An optical unit comprising:
a first display panel configured to emit first image light;
a second display panel configured to emit second image light having a wavelength region different from a wavelength region of the first image light;
a third display panel configured to emit third image light having a wavelength region different from the wavelength regions of the first image light and the second image light;
a cross dichroic prism including a first light incident surface on which the first image light is incident, a second light incident surface on which the second image light is incident, and a third light incident surface on which the third image light is incident, and configured to synthesize the first image light, the second image light, and the third image light and emit synthesized image light from a light emission surface;
a projection optical system including an optical path bending prism having a first transmission surface on which the image light from the cross dichroic prism is incident, a first reflection surface and a second reflection surface that reflect the image light transmitted through the first transmission surface, and a second transmission surface that emits the image light reflected by the second reflection surface; and
a light-guiding member configured to guide the image light emitted from the projection optical system to a pupil position at which an eye is located.
